(19) United States
(12) Patent Application Publication
(10) Pub. No.: US 2020/0057449 A1
(43) Pub. Date: Feb. 20, 2020

(54) VACUUM CLEANER

(71) Applicant: TOSHIBA LIFESTYLE PRODUCTS & SERVICES CORPORATION, Kawasaki-shi (JP)

(72) Inventors: Kota WATANABE, Owariasahi (JP); Hirokazu IZAWA, Aisai (JP); Yuuki MARUTANI, Nagakute (JP)

(73) Assignee: TOSHIBA LIFESTYLE PRODUCTS & SERVICES CORPORATION, Kawasaki-shi (JP)

(21) Appl. No.: 16/604,390

(22) PCT Filed: May 22, 2018
(86) PCT No.: PCT/JP2018/019633

§ 371 Date: Oct. 10, 2019

(30) Foreign Application Priority Data
May 23, 2017 (JP) 2017-101943

(51) Int. Cl. G05D 1/02; A47L 9/28; A47L 11/40; A47L 9/30; G05D 1/00

(52) U.S. Cl. CPC G05D 1/0238; A47L 9/2826; A47L 9/2852; A47L 11/4011; A47L 11/4061; G05D 2201/0203; G05D 1/0088; G05D 1/0214; A47L 2201/04; G05D 2201/0215; A47L 9/30

(57) ABSTRACT

A vacuum cleaner includes a main casing, a driving wheel, a camera, an obstacle detection part, a lamp, and a control unit. The driving wheel allows the main casing to travel. The camera is disposed on the main casing to capture an image in a traveling direction side of the main casing. The obstacle detection part performs detection of an obstacle on a basis of the image captured by the camera. The lamp assists the detection performed by the obstacle detection part. The control unit makes the main casing travel autonomously, by controlling driving of the driving wheel on a basis of the detection of the obstacle performed by the obstacle detection part. The vacuum cleaner can secure accuracy in obstacle detection.

### TECHNICAL FIELD

Embodiments described herein relate generally to a vacuum cleaner including a camera for capturing an image in a traveling direction side of a main body.

### BACKGROUND ART

Conventionally, a so-called autonomously-traveling type vacuum cleaner (a cleaning robot) has been known, which cleans a floor surface as a cleaning-object surface while autonomously traveling on the floor surface.

A technology for performing efficient cleaning by such a vacuum cleaner is provided, by which a map is generated (through mapping) by reflecting the size and shape of a room to be cleaned and an obstacle or the like on the map, and thereafter an optimum traveling route is set on the basis of the map, and then traveling is performed along the traveling route. In an example, such a map is generated on the basis of the images captured by use of the camera disposed on a main casing.

In the case where a map is generated as described above, a distance to the captured object is detected on the basis of the feature points extracted from the image captured by the camera, and whether or not the object corresponds to an obstacle is determined. However, in the case where a monochrome pattern covers all over the image range of the camera, for example, the case where the vacuum cleaner approaches a wall or an obstacle to a close range, the case where the vacuum cleaner enters into a dark place such as under a bed, and the case where the camera is exposed to strong backlight, the feature points of the image are not able to be detected, or an extremely decreased number of feature points are detected. In this case, normal detection of a targeted object is hard.

### CITATION LIST

### Patent Literature

PTL 1: Patent publication No. 5426603

### SUMMARY OF INVENTION

### Technical Problem

The technical problem to be solved by the present invention is to provide a vacuum cleaner capable of securing accuracy in obstacle detection.

### Solution to Problem

A vacuum cleaner according to an embodiment has a main body, a travel driving part, a camera, an obstacle detection part, a detection assisting part and a controller. The travel driving part allows the main body to travel. The camera is disposed on the main body so as to capture an image in a traveling direction side of the main body. The obstacle detection part detects an obstacle on the basis of the image captured by the camera. The detection assisting part assists the detection performed by the obstacle detection part. The controller makes the main body travel autonomously, by controlling driving of the travel driving part on the basis of the detection of the obstacle performed by the obstacle detection part.

### BRIEF DESCRIPTION OF DRAWINGS

FIG. 1 is a block diagram illustrating a vacuum cleaner according to a first embodiment;

FIG. 2 is a perspective view illustrating a vacuum cleaning system including the vacuum cleaner;

FIG. 3 is a plan view illustrating the vacuum cleaner as viewed from below;

FIG. 4 is an explanatory view schematically illustrating the vacuum cleaning system including the vacuum cleaner;

FIG. 5 is a side view schematically illustrating a detection assisting part of the vacuum cleaner;

FIG. 6 is a perspective view illustrating the state in which the detection assisting part performs detection assisting;

FIG. 7 is an explanatory view schematically illustrating a method of calculating a distance to an object by use of cameras of the vacuum cleaner;

FIG. 8(a) is a front view schematically illustrating a detection assisting part of a vacuum cleaner according to a second embodiment, and FIG. 8(b) is a side view schematically illustrating the detection assisting part;

FIG. 9 is a perspective view illustrating the state in which the detection assisting part performs detection assisting;

FIG. 10 is a block diagram illustrating a vacuum cleaner according to a third embodiment;

FIG. 11 is an explanatory view schematically illustrating a vacuum cleaning system including the vacuum cleaner; and

FIG. 12 is a block diagram illustrating a vacuum cleaner according to a fourth embodiment.

### DESCRIPTION OF EMBODIMENT

The configuration of the first embodiment is described below with reference to the drawings.

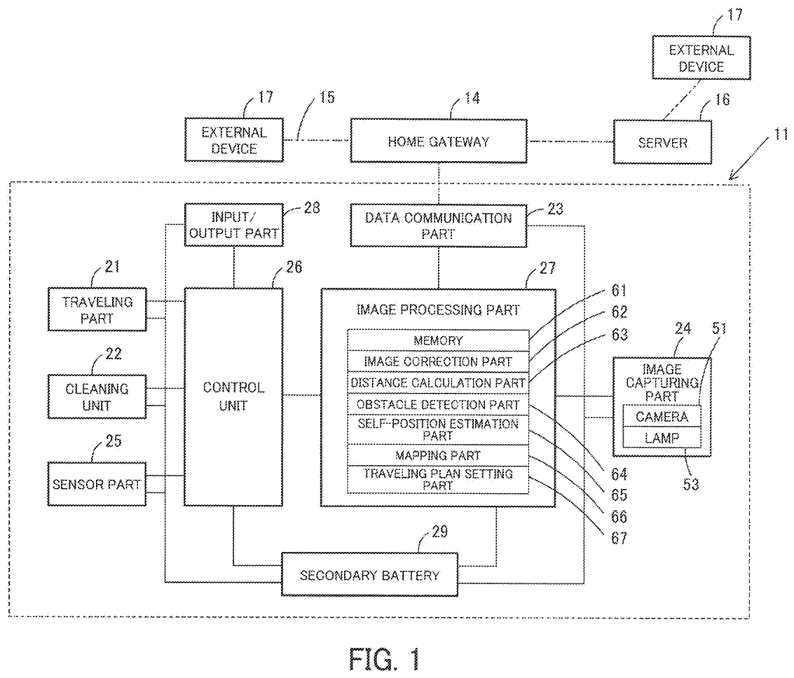

In FIG. 1 to FIG. 4, reference sign 11 denotes a vacuum cleaner as an autonomous traveler. The vacuum cleaner 11 constitutes a vacuum cleaning apparatus (a vacuum cleaning system) serving as an autonomous traveler device in combination with a charging device (a charging table) 12 serving as a station device corresponding to a base station for charging the vacuum cleaner 11. In the present embodiment, the vacuum cleaner 11 is a so-called self-propelled robot cleaner (a cleaning robot), which autonomously travels (self-travels) on a floor surface that is a cleaning-object surface as a traveling surface while cleaning the floor surface. In an example, the vacuum cleaner 11 is capable of performing wired or wireless communication via a (an external) network 15 such as the Internet or the like with a general-purpose server 16 serving as data storage means (a data storage section), a general-purpose external device 17 such as a smartphone or a PC serving as a display terminal (a display part), or the like by performing communication (transmission/reception of data) with a home gateway (a router) 14 serving as relay means (a relay part) disposed in a cleaning area or the like by using wired communication or wireless communication such as Wi-Fi (registered trademark), Bluetooth (registered trademark), or the like.

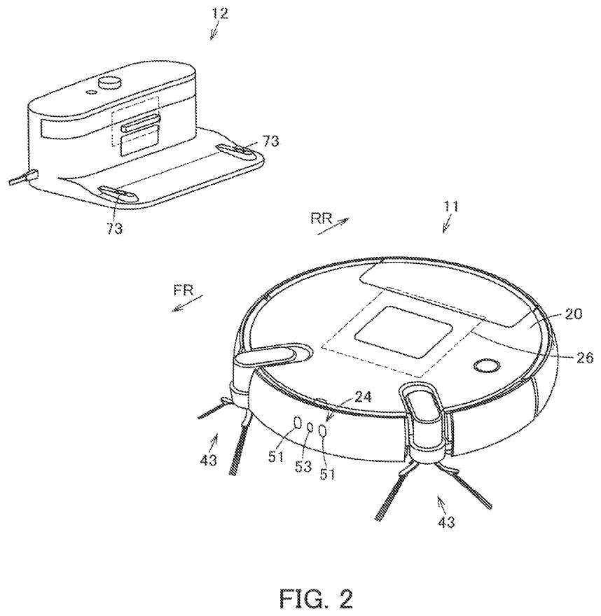

The vacuum cleaner 11 includes a main casing 20 which is a hollow main body. The vacuum cleaner 11 further includes a traveling part 21. The vacuum cleaner 11 further includes a cleaning unit 22 for removing dust and dirt. The vacuum cleaner 11 further includes a data communication part 23 serving as data communication means serving as information transmitting means for performing wired communication or wireless communication via the network 15. The vacuum cleaner 11 further includes an image capturing part 24 for capturing images. The vacuum cleaner 11 further includes a sensor part 25. The vacuum cleaner 11 further includes a control unit 26 serving as control means which is a controller. The vacuum cleaner 11 further includes an image processing part 27 serving as image processing means which is a graphics processing unit (GPU). The vacuum cleaner 11 further includes an input/output part 28 with which signals are input and output between an external device. The vacuum cleaner 11 includes a secondary battery 29 which is a battery for power supply. It is noted that the following description will be given on the basis that a direction extending along the traveling direction of the vacuum cleaner 11 (the main casing 20) is treated as a back-and-forth direction (directions of an arrow FR and an arrow RR shown in FIG. 2), while a left-and-right direction (directions toward both sides) intersecting (orthogonally crossing) the back-and-forth direction is treated as a widthwise direction.

The main casing 20 is formed of, for example, synthetic resin or the like. The main casing 20 may be formed into, for example, a flat columnar shape (a disk shape) or the like. The main casing 20 may have a suction port 31 or the like which is a dust-collecting port, in the lower part or the like facing the floor surface.

The traveling part 21 includes driving wheels 34 serving as a travel driving part. The traveling part 21 further includes motors not shown which correspond to driving means for driving the driving wheels 34. That is, the vacuum cleaner 11 includes the driving wheels 34 and the motors for driving the driving wheels 34. It is noted that the traveling part 21 may include a swing wheel 36 for swinging or the like.

The driving wheels 34 are used to make the vacuum cleaner 11 (the main casing 20) travel (autonomously travel) on the floor surface in the advancing direction and the retreating direction. That is, the driving wheels 34 serve for traveling use. In the present embodiment, a pair of the driving wheels 34 is disposed, for example, on the left and right sides of the main casing 20. It is noted that a crawler or the like may be used as a travel driving part, instead of these driving wheels 34.

The motors are disposed to correspond to the driving wheels 34. Accordingly, in the present embodiment, a pair of the motors is disposed on the left and right sides, for example. The motors are capable of independently driving each of the driving wheels 34.

The cleaning unit 22 is configured to remove dust and dirt on, for example, a floor surface, a wall surface, or the like. In an example, the cleaning unit 22 has the function of collecting and catching dust and dirt on a floor surface through the suction port 31, and/or wiping a wall surface. The cleaning unit 22 may further include at least one of an electric blower 40 for sucking dust and dirt together with air through the suction port 31, a rotary brush 41 serving as a rotary cleaner rotatably attached to the suction port 31 to scrape up dust and dirt and a brush motor for rotationally driving the rotary brush 41, side brushes 43 which correspond to auxiliary cleaning means (auxiliary cleaning parts) serving as swinging-cleaning parts rotatably attached on both sides of the front side of the main casing 20 or the like to scrape up dust and dirt as well as side brush motors for driving the side brushes 43. The cleaning unit 22 may further include a dust-collecting unit which communicates with the suction port 31 to accumulate dust and dirt.

The data communication part 23 is, for example, a wireless LAN device for exchanging various types of information with the external device 17 via the home gateway 14 and the network 15. It is noted that the data communication part 23 may have an access point function so as to perform direct wireless communication with the external device 17 without the home gateway 14. The data communication part 23 may additionally have, for example, a web server function.

The image capturing part 24 includes a camera 51 serving as image capturing means (an image-pickup-part main body). That is, the vacuum cleaner 11 includes the camera 51 serving as image capturing means (an image-pickup-part main body). The image capturing part 24 may include a lamp 53 serving as detection assisting means (a detection assisting part). That is, the vacuum cleaner 11 may include the lamp 53 serving as detection assisting means (a detection assisting part).

The camera 51 is a digital camera for capturing digital images of the forward direction which is the traveling direction of the main casing 20 at a specified horizontal angle of view (such as 105 degrees) and at specified time intervals, for example, at a micro-time basis such as several tens of milliseconds or the like, or at a several-second basis or the like. The camera 51 may be configured as one camera or as plural cameras. In the present embodiment, a pair of the cameras 51 is disposed on the left and right sides. That is, the cameras 51 are disposed apart from each other on the left side and the right side of the front portion of the main casing 20. The cameras 51, 51 have image ranges (fields of view) overlapping with each other. Accordingly, the image ranges of the images captured by these cameras 51, 51 overlap with each other in the left-and-right direction. It is noted that the camera 51 may capture, for example, a color image or a black/white image in a visible light region, or an infrared image. The image captured by the camera 51 may be compressed into a specified data format by, for example, the image processing part 27.

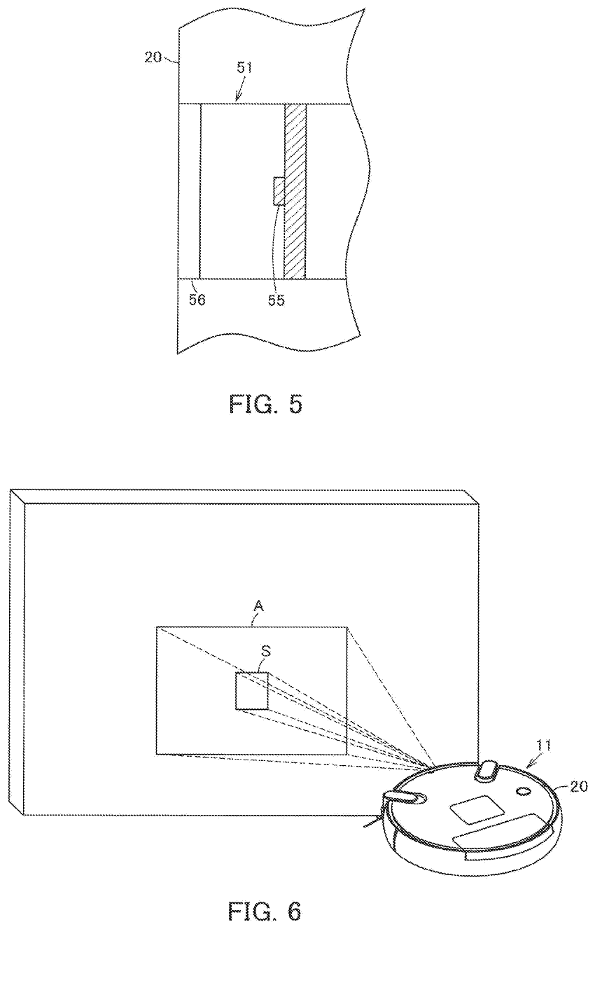

The lamp 53 serves as illumination means (an illumination body) for assisting obstacle detection to be described below, by radiating light, which is infrared light in the present embodiment, to form a specified shape in the image range of the camera 51. In the present embodiment, the lamp 53 is disposed at an intermediate position between the cameras 51, 51, so as to correspond to each of the cameras 51. That is, in the present embodiment, a pair of the lamps 53 is disposed. The lamp 53 is configured to emit light according to the wavelength range of the light to be captured by the camera 51. Accordingly, the lamp 53 may radiate light containing visible light region, or may radiate infrared light. As shown in FIG. 5, the lamp 53 includes a lamp main body 55 serving as an illumination means main body (an illumination main body) and a cover 56 which is transparent (has translucency) and covers the light-radiating side of the lamp main body 55. For example, an LED light or a laser having directivity serves as the lamp main body 55. In the present embodiment, the lamp main body 55 (the lamp 53) is capable of radiating a light (spot) S to form, for example, a square shape substantially at a central portion in the image range of the cameras 51 (FIG. 6).

The sensor part 25 shown in FIG. 1 is configured to sense various types of information to be used to support the traveling of the vacuum cleaner 11 (the main casing 20 (FIG. 2)). More specifically, the sensor part 25 is configured to sense, for example, an uneven state (a step gap) of the floor surface, a wall that would be an obstacle to traveling, an obstacle, or the like. That is, the sensor part 25 includes a step gap sensor, an obstacle sensor or the like, such as an infrared sensor, a contact sensor, or the like.

For example, a microcomputer including a CPU corresponding to a control means main body (a control unit main body), a ROM, and a RAM or the like is used as the control unit 26. The control unit 26 includes a travel control part not shown, which is electrically connected to the traveling part 21. The control unit 26 further includes a cleaning control part not shown, which is electrically connected to the cleaning unit 22. The control unit 26 further includes a sensor connection part not shown, which is electrically connected to the sensor part 25. The control unit 26 further includes a processing connection part not shown, which is electrically connected to the image processing part 27. The control unit 26 further includes an input/output connection part not shown, which is electrically connected to the input/output part 28. That is, the control unit 26 is electrically connected to the traveling part 21, the cleaning unit 22, the sensor part 25, the image processing part 27 and the input/output part 28. The control unit 26 is further electrically connected to the secondary battery 29. The control unit 26 includes, for example, a traveling mode for driving the driving wheels 34, that is, the motors, to make the vacuum cleaner 11 (the main casing 20 (FIG. 2)) travel autonomously, a charging mode for charging the secondary battery 29 via the charging device 12 (FIG. 2), and a standby mode applied during a standby state.

The travel control part is configured to control the operation of the motors of the traveling part 21. That is, the travel control part controls the magnitude and the direction of the current flowing through the motors to rotate the motors in a normal or reverse direction to control the operation of the motors, and by controlling the operation of the motors, controls the operation of the driving wheels 34.

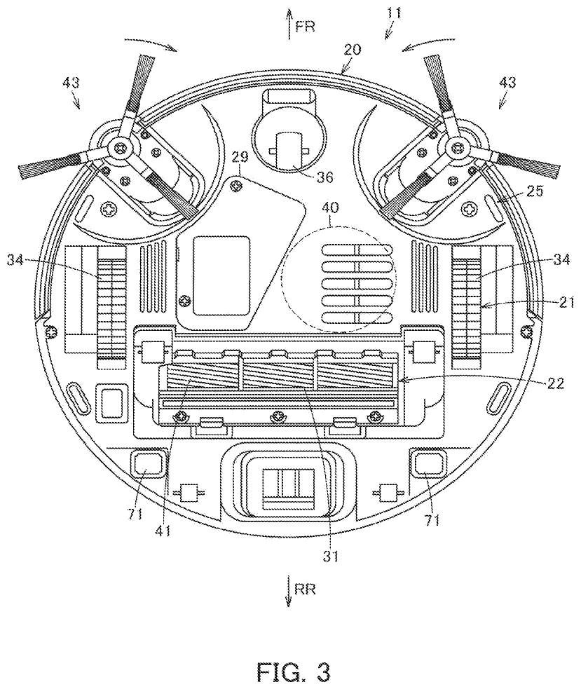

The cleaning control part controls the operation of the electric blower 40, the brush motor and the side brush motors of the cleaning unit 22 shown in FIG. 3. That is, the cleaning control part controls each of the current-carrying quantities of the electric blower 40, the brush motor and the side brush motors individually, thereby controlling the operation of the electric blower 40, the brush motor (the rotary brush 41) and the side brush motors (the side brushes 43).

The sensor connection part is configured to acquire the detection result by the sensor part 25.

The processing connection part is configured to acquire the setting result set on the basis of the image processing by the image processing part 27 shown in FIG. 1.

The input/output connection part is configured to acquire a control command via the input/output part 28, and to output a signal to be output by the input/output part 28 to the input/output part 28.

The image processing part 27 is configured to perform image processing to the images (the original images) captured by the cameras 51. More specifically, the image processing part 27 is configured to extract feature points by the image processing from the images captured by the cameras 51 to detect a distance to an obstacle and a height thereof, and thereby generate the map of the cleaning area, and estimate the current position of the vacuum cleaner 11 (the main casing 20 (FIG. 2)). The image processing part 27 is, for example, an image processing engine including a CPU corresponding to an image processing means main body (an image processing part main body), a ROM, and a RAM or the like. The image processing part 27 includes a camera control part not shown, which controls the operation of the cameras 51. The image processing part 27 further includes an illumination control part not shown, which controls the operation of the lamps 53. Accordingly, the image processing part 27 is electrically connected to the image capturing part 24. The image processing part 27 further includes a memory 61 serving as storage means (a storage section). That is, the vacuum cleaner 11 includes the memory 61 serving as storage means (a storage section). The image processing part 27 serving as image processing storage means (a storage section) includes an image correction part 62 for generating corrected images obtained by correcting the original images captured by the cameras 51. That is, the vacuum cleaner 11 includes the image correction part 62. The image processing part 27 further includes a distance calculation part 63 serving as distance calculation means for calculating a distance to an object positioned in the traveling direction side on the basis of the images. That is, the vacuum cleaner 11 includes the distance calculation part serving as distance calculation means. The image processing part 27 further includes an obstacle determination part 64 serving as obstacle detection means for determining an obstacle on the basis of the calculated distance to an object by the distance calculation part 63. That is, the vacuum cleaner 11 includes the obstacle determination part 64 serving as obstacle detection means. The image processing part 27 further includes a self-position estimation part 65 serving as self-position estimation means for estimating the self-position of the vacuum cleaner 11 (the main casing 20). That is, the vacuum cleaner 11 includes the self-position estimation part 65 serving as self-position estimation means. The image processing part 27 further includes a mapping part 66 serving as mapping means for generating the map of the cleaning area corresponding to the traveling area. That is, the vacuum cleaner 11 includes the mapping part 66 serving as mapping means. The image processing part 27 further includes a traveling plan setting part 67 serving as traveling plan setting means for setting a traveling plan (a traveling route) of the vacuum cleaner 11 (the main casing 20). That is, the vacuum cleaner 11 includes the traveling plan setting part 67 serving as traveling plan setting means.

The camera control part includes a control circuit for controlling, for example, the operation of the cameras 51, and controls the cameras 51 to capture a video image or controls the cameras 51 to capture images at a predetermined time intervals.

The illumination control part corresponds to detection assistance control means (a detection assistance control part), and controls turning-on and turning-off of the lamps 53 via, for example, a switch. The illumination control part is configured to turn on the lamps 53 (the lamp main bodies 55) under a predetermined condition, for example, when the images captured by the cameras 51 are substantially uniform in luminance (when the variance (difference between the maximum value and the minimum value) of luminance is less than a predetermined value). The luminance herein of the images captured by the cameras 51 may be the luminance of the entire image, or may be the luminance within a predetermined image range in the image.

It is noted that the camera control part and the illumination control part may be configured as a device of camera control means (a camera control part) which is separate from the image processing part 27, or alternatively, may be disposed in, for example, the control unit 26.

The memory 61 stores various types of data, such as image data captured by the cameras 51, and the map generated by the mapping part 66. A non-volatile memory, for example, a flash memory, serves as the memory 61, which retains the various types of stored data regardless of whether the vacuum cleaner 11 is powered on or off.

The image correction part 62 performs primary image processing to the original images captured by the cameras 51, such as correcting distortion of the lenses, noise reduction, contrast adjusting, and matching the centers of images or the like.

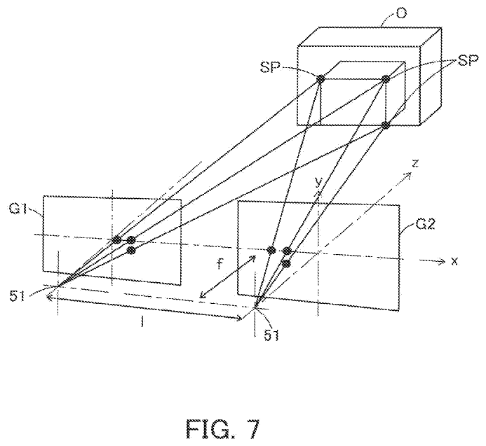

The distance calculation part 63 calculates a distance (depth) of an object (feature points) and the three-dimensional coordinates thereof by a known method on the basis of the images captured by the cameras 51, which in the present embodiment are the corrected images captured by the cameras 51 and corrected thereafter by the image correction part 62 as well as the distance between the cameras 51. That is, as shown in FIG. 7, the distance calculation part 63 applies triangulation based on a depth f of the cameras 51, a distance (parallax) from the cameras 51 to an object (feature points) of an image G1 and an image G2 captured by the cameras 51, and a distance I between the cameras 51, to detect pixel dots indicative of identical positions in each of the images (the corrected images processed by the image correction part 62 (FIG. 1)) captured by the cameras 51, and to calculate angles of the pixel dots in the up-and-down direction, the left-and-right direction and the back-and-forth direction, thereby calculating a height and a distance of the positions from the cameras 51 on the basis of these angles and the distance between the cameras 51, while also calculating the three-dimensional coordinate of the object O (feature points SP). Therefore, it is preferable that, in the present embodiment the areas of the images captured by the cameras 51 overlap with each other as much as possible. It is noted that the distance calculation part 63 shown in FIG. 1 may generate the distance image (the parallax image) indicating the calculated distance of the object. The distance image is generated by displaying each of the calculated pixel-dot-basis distances by converting them into visually discernible gradation levels such as brightness, color tone or the like on a specified dot basis, such as one-dot basis or the like. Accordingly, the distance image is obtained by, as it were, visualizing a mass of distance information (distance data) on the objects positioned within the range captured by the cameras 51 located in the forward direction of the vacuum cleaner 11 (the main casing 20) shown in FIG. 2 in the traveling direction. It is noted that the feature points can be extracted by performing, for example, edge detection or the like with respect to the image corrected by the image correction part 62 shown in FIG. 1 or the distance image. Any known method can be used as the edge detection method.

The obstacle detection part 64 detects an obstacle on the basis of the images captured by the cameras 51. More specifically, the obstacle detection part 64 determines whether or not the obstacle subjected to calculation of a distance by the distance calculation part 63 corresponds to an obstacle. That is, the obstacle detection part 64 extracts a part of a predetermined image area on the basis of the calculated distance of the obstacle by the distance calculation part 63, and compares the distance of the captured object in the image area with a set distance corresponding to a threshold value previously set or variably set, thereby determining that the object positioned away by the set distance (the distance from the vacuum cleaner 11 (the main casing 20 (FIG. 2))) or shorter corresponds to an obstacle. The image area described above is set according to, for example, the vertical and lateral sizes of the vacuum cleaner 11 (the main casing 20) shown in FIG. 2. That is, the vertical and lateral sizes of the image area herein are set so that the vacuum cleaner 11 (the main casing 20) when traveling straight as it is comes into contact with the area.

The self-position estimation part 65 shown in FIG. 1 is configured to determine the self-position of the vacuum cleaner 11 and whether or not any object corresponding to an obstacle exists, on the basis of the three-dimensional coordinates of the feature points of the object calculated by the distance calculation part 63. The mapping part 66 generates the map indicating the positional relation and the heights of objects (obstacles) or the like positioned in the cleaning area in which the vacuum cleaner 11 (the main casing 20 (FIG. 2)) is located, on the basis of the three-dimensional coordinates of the feature points calculated by the distance calculation part 63. That is, for the self-position estimation part 65 and the mapping part 66, the known technology of simultaneous localization and mapping (SLAM) can be used.

The mapping part 66 is configured to generate the map of the traveling area by use of three-dimensional data based on the calculation results by the distance calculation part 63 and the self-position estimation part 65. The mapping part 66 generates the map by use of any method on the basis of the images captured by the cameras 51, that is, the three-dimensional data on the objects calculated by the distance calculation part 63. In other words, the map data includes the three-dimensional data, that is, the two-dimensional arrangement position data and the height data of objects. The map data may further include traveling path data indicating the traveling path of the vacuum cleaner 11 (the main casing 20 (FIG. 2)) during the cleaning.

The traveling plan setting part 67 sets the optimum traveling route on the basis of the map generated by the mapping part 66 and the self-position estimated by the self-position estimation part 65. As the optimum traveling route to be generated herein, a route which can provide efficient traveling (cleaning) is set, such as the route which can provide the shortest traveling distance for traveling in an area possible to be cleaned in the map (an area excluding a part where traveling is impossible due to an obstacle, a step gap or the like), for example, the route where the vacuum cleaner 11 (the main casing 20 (FIG. 2)) travels straight as long as possible (where directional change is least required), the route where contact with an object as an obstacle is less, or the route where the number of times of redundantly traveling the same location is the minimum, or the like. It is noted that in the present embodiment the traveling route set by the traveling plan setting part 67 refers to the data (traveling route data) developed in the memory 61 or the like.

The input/output part 28 is configured to acquire a control command transmitted by an external device such as a remote controller not shown, and/or a control command input through input means such as a switch disposed on the main casing 20 (FIG. 2), a touch panel, or the like, and also transmit a signal to, for example, the charging device 12 (FIG. 2). The input/output part 28 includes transmission means (a transmission part) not shown, such as an infrared light emitting element for transmitting wireless signals (infrared signals) to, for example, the charging device 12 (FIG. 2). The input/output part 28 further includes reception means (a reception part) or the like not shown, such as a phototransistor for receiving wireless signals (infrared signals) from the charging device 12 (FIG. 2), a remote controller, or the like.

The secondary battery 29 is configured to supply electric power to the traveling part 21, the cleaning unit 22, the data communication part 23, the image capturing part 24, the sensor part 25, the control unit 26, the image processing part 27, and the input/output part 28 or the like. The secondary battery 29 is electrically connected to charging terminals 71 (FIG. 3) serving as connection parts exposed at the lower portions of the main casing 20 (FIG. 2), as an example, and by electrically and mechanically connecting the charging terminals 71 (FIG. 3) to the side of the charging device 12 (FIG. 2), the secondary battery 29 is charged via the charging device 12 (FIG. 2).

The charging device 12 shown in FIG. 2 incorporates a charging circuit, such as a constant current circuit or the like. The charging device 12 includes terminals for charging 73 to be used to charge the secondary battery 29 (FIG. 1). The terminals for charging 73 are electrically connected to the charging circuit and are configured to be mechanically and electrically connected to the charging terminals 71 (FIG. 3) of the vacuum cleaner 11 which has returned to the charging device 12.

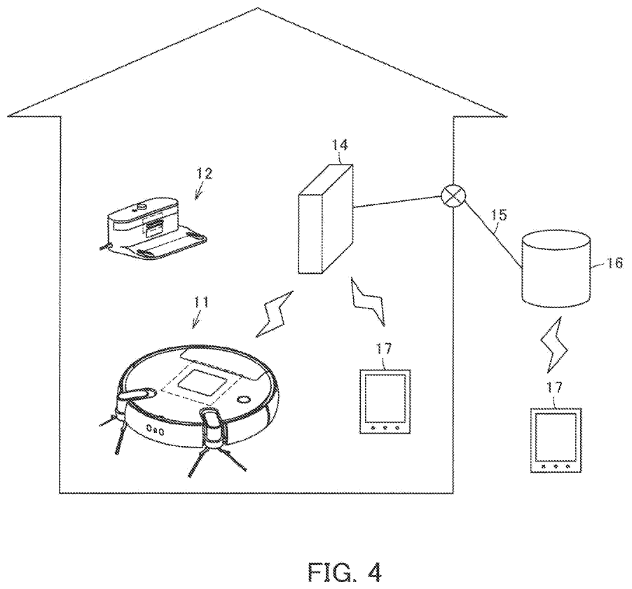

The home gateway 14 shown in FIG. 4, which is also called an access point or the like, is disposed inside a building so as to be connected to the network 15 by, for example, wire.

The server 16, which is a computer (a cloud server) connected to the network 15, is capable of storing various types of data.

The external device 17 is a general-purpose device, such as a PC (a tablet terminal (a tablet PC)), a smartphone (a mobile phone), or the like, which is capable of performing wired or wireless communication with the network 15 via, for example, the home gateway 14 inside a building, and performing wired or wireless communication with the network 15 outside the building. The external device 17 has a display function for displaying at least an image.

The operation of the above-described first embodiment is described below with reference to the drawings.

In general, the work of the vacuum cleaning apparatus is roughly divided into cleaning work for carrying out cleaning by the vacuum cleaner 11, and charging work for charging the secondary battery 29 with the charging device 12. The charging work is implemented by a known method using the charging circuit incorporated in the charging device 12. Accordingly, only the cleaning work will be described. Also, image capturing work for capturing images of a specified object by the cameras 51 in response to an instruction issued by the external device 17 or the like may be included separately.

The outline from the start to the end of the cleaning is described first. The vacuum cleaner 11 undocks from the charging device 12 when starting the cleaning. In the case where the map is not stored in the memory 61, the mapping part 66 generates the map on the basis of the images captured by the cameras 51 or the like, and thereafter the cleaning unit 22 performs the cleaning, while the control unit 26 controls the vacuum cleaner 11 (the main casing 20) to travel along the traveling route set by the traveling plan setting part 67 on the basis of the map. In the case where the map is stored in the memory 61, the cleaning unit 22 performs the cleaning, while the control unit 26 controls the vacuum cleaner 11 (the main casing 20) to travel along the traveling route set by the traveling plan setting part 67 on the basis of the map. During the cleaning, the mapping part 66 detects the two-dimensional arrangement position and the height of an object on the basis of the images captured by the cameras 51, reflects the detected result on the map, and stores the map in the memory 61. After the cleaning is finished, the control unit 26 performs travel control so as to make the vacuum cleaner 11 (the main casing 20) return to the charging device 12, and after the vacuum cleaner 11 returns to the charging device 12, the control unit 26 is switched over to the charging work for charging the secondary battery 29 at specified timing.

In more detail, in the vacuum cleaner 11, the control unit 26 is switched over from the standby mode to the traveling mode at a certain timing, such as when a preset cleaning start time arrives, when the input/output part 28 receives a control command to start the cleaning which is transmitted by a remote controller or the external device 17, or the like, and thereafter, the control unit 26 (the travel control part) drives the motors (the driving wheels 34) to make the vacuum cleaner 11 undock and move from the charging device 12 by a specified distance.

The vacuum cleaner 11 then determines whether or not the map is stored in the memory 61, by referring to the memory 61. In the case where the map is not stored in the memory 61, the mapping part 66 generates the map of the cleaning area on the basis of the images captured by the cameras 51 and the obstacle detected by the sensor part 25 by a contact or non-contact manner, while the vacuum cleaner 11 (the main casing 20) is made to travel (for example, turn), and on the basis of the generated map, the traveling plan setting part generates the optimum traveling route. After the generation of the map of the entire cleaning area, the control unit 26 is switched over to the cleaning mode to be described below.

Meanwhile, in the case where the map is stored in the memory 61 in advance, the traveling plan setting part 67 generates the optimum traveling route on the basis of the map stored in the memory 61, without generating the map.

Then, the vacuum cleaner 11 performs the cleaning while autonomously traveling in the cleaning area along the traveling route generated by the traveling plan setting part 67 (cleaning mode). In the cleaning mode, for example, the electric blower 40, the brush motor (the rotary brush 41) or the side brush motors (the side brushes 43) of the cleaning unit 22 is driven by the control unit 26 (the cleaning control part) to collect dust and dirt on the floor surface into the dust-collecting unit through the suction port 31.

In overview of the autonomous traveling, the vacuum cleaner 11 captures the images of the forward direction in the advancing direction by the cameras 51, while operating the cleaning unit 22 and advancing along the traveling route. The vacuum cleaner 11 further detects an object corresponding to an obstacle by the obstacle detection part 64, senses the surrounding thereof by the sensor part 25, and periodically estimates the self-position by the self-position estimation part 65. The vacuum cleaner 11 repeats such operations. At this time, in the case where there is a wall without any pattern in front of the vacuum cleaner 11 (the main casing 20) in the traveling direction, or the case where the vacuum cleaner 11 approaches an obstacle to a close range, as an example, the images captured by the cameras 51 are supposed to be substantially uniform in luminance, and thus have no feature point, or have extremely decreased feature points. In this case, the illumination control part turns on the lamps 53 (the lamp main bodies 55), whereby the light S is formed, which has a specified shape with respect to an object existing in front of the vacuum cleaner 11 (the main casing 20) in the traveling direction. The light Shaving a specified shape is formed substantially at the central portion in an image range A of the left and right cameras 51 (FIG. 6). Accordingly, feature points are able to be extracted from the formed specified shape. In an example, in the case of the light S having a square shape, the four corners and the four sides of the shape are able to be extracted as the feature points. The mapping part 66 reflects the detailed information (height data) on the feature points on the map on the basis of the extracted feature points, thereby enabling to complete the map. Thereby, the self-position estimation part 65 is also able to estimate the self-position of the vacuum cleaner 11 (the main casing 20).

After traveling along the set entire traveling route, the vacuum cleaner 11 returns to the charging device 12. The control unit 26 is switched over from the traveling mode to the charging mode in which the secondary battery 29 is charged, at appropriate timing, such as just after the returning, the timing when a predetermined period of time elapses after the returning, or the timing when a preset time arrives.

It is noted that the completed map data may be stored not only in the memory 61, but also transmitted and stored in the server 16 via the data communication part 23 and via the network 15, and/or may be transmitted to the external device 17 to be stored in a memory of the external device 17 or to be displayed on the external device 17.

The above-described first embodiment utilizes the lamps 53 for radiating light to form a predetermined shape in the image range of the cameras 51 and thereby to form feature points on the images captured by the cameras 51, whereby the obstacle detection part 64 is able to detect an obstacle on the basis of the feature points. Accordingly, even in the case where there is an obstacle such as a wall with less pattern in front of the vacuum cleaner 11 (the main casing 20) in the traveling direction, or even in the case where the vacuum cleaner 11 (the main casing 20) approaches an obstacle to a close range, the present embodiment allows reliable detection of an obstacle, and thus enables to ensure the accuracy in obstacle detection.

Especially, since the lamps 53 radiate infrared light, an owner or the like does not visually observe the specified shape which is formed by an obstacle irradiated by the lamps 53. Such processing for generating the feature points is enabled to be performed without the recognition by a user, in other words, without giving unease or discomfort to a user.

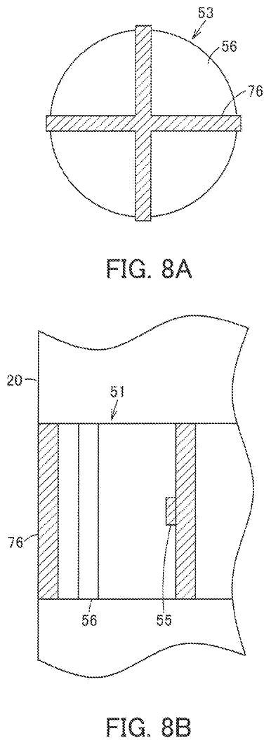

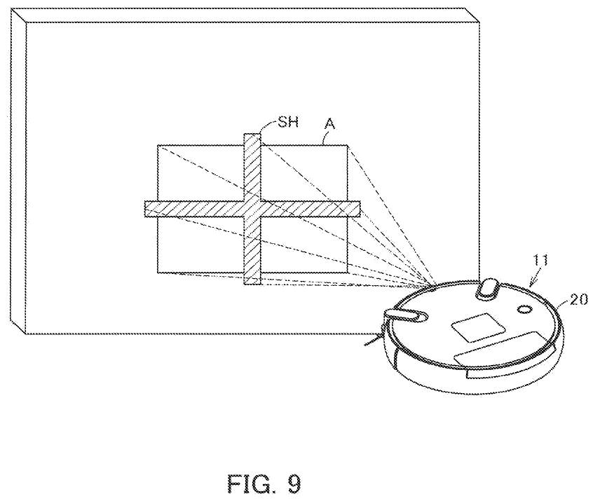

The second embodiment is described below with reference to FIG. 8 and FIG. 9. It is noted that identical reference signs are assigned to the configurations and the effects similar to those of the first embodiment described above, and the descriptions thereof are thus omitted.

In the second embodiment, the above-described lamps 53 correspond to projection means (a projection part) for projecting a specified shape into the image range of the cameras 51.

That is, each of the lamps 53 includes alight shielding member 76 attached on the side opposite to the lamp main body 55 with respect to the cover 56, that is, the radiation side of the light radiated by the lamp main body 55 with respect to the cover 56. The light shielding member 76 is configured to project a predetermined shape by partially shielding the light radiated by the lamp main body 55. The light shielding member 76 may be formed in any shape. In the present embodiment, the light shielding member 76 is formed in, for example, a cross shape. Accordingly, the light radiated by the lamp 53 (the lamp main body 55) is partially shielded by the light shielding member 76, thereby forming a shade SH having a specified shape with respect to an object existing in front of the vacuum cleaner 11 (the main casing 20) in the traveling direction.

Accordingly, in the case where there is a wall without any pattern in front of the vacuum cleaner 11 (the main casing 20) when traveling in the traveling direction, or in the case where the vacuum cleaner 11 approaches an obstacle to a close range, as an example, the images captured by the cameras 51 are substantially uniform in luminance, and thus have no feature point, or have extremely decreased feature points. In this case, the illumination control part turns on the lamps 53 (the lamp main bodies 55), whereby the shade SH is formed, which has a specified shape with respect to an object existing in front of the vacuum cleaner 11 (the main casing 20) in the traveling direction. The shade SH having a specified shape is formed so as to extend from the substantial center to the outer edges of the image range A of the left and right cameras 51. Feature points are able to be extracted from the formed specified shape. In an example, in the case of the shade SH having a cross shape, the crossing position of the cross shape and the sides of the cross shape extending in the four directions are able to be extracted as feature points. The mapping part 66 reflects the detailed information (height data) on the feature points on the map on the basis of the extracted feature points, thereby enabling to complete the map. The self-position estimation part 65 is also able to estimate the self-position of the vacuum cleaner 11 (the main casing 20).

As described above, the lamps 53 project the shade SH having a specified shape in the image range of the cameras 51 by use of the shielding member 76, thereby forming feature points in the images captured by the cameras 51. Therefore, the obstacle detection part 64 is able to detect an obstacle on the basis of the feature points. Accordingly, even in the case where there is an obstacle such as a wall with less pattern in front of the vacuum cleaner 11 (the main casing 20) in the traveling direction, or even in the case where the vacuum cleaner 11 (the main casing 20) approaches an obstacle to a close range, the obstacle detection part 64 is able to detect an obstacle reliably, thereby enabling to ensure the accuracy in obstacle detection.

Furthermore, only the arrangement of the light shielding member 76 in the radiation side of the light radiated by the lamp 53 enables to facilitate the formation of the shade SH in a desired shape.

According to at least one of the embodiments described above, the light S radiated by the lamps 53 or the shade SH having a specified shape is formed substantially at the central portion in the image range by the cameras 51, whereby the light S or the shade SH is enabled to be surely captured by the plurality of cameras 51 on the images, and further enabled to be easily discriminated from other obstacles on the basis of the extracted feature points. Especially, in the case where the vacuum cleaner 11 (the main casing 20) is positioned close to an obstacle, obvious parallax by the left and right cameras 51 is likely to occur, and a large amount of displacement with respect to the identical point in the images captured by the left and right cameras 51 is thus generated. Therefore, the formation of the light S or the shade SH substantially at the central portion in the images ensures the formation of the light S or the shade SH in the image range of the left and right cameras 51.

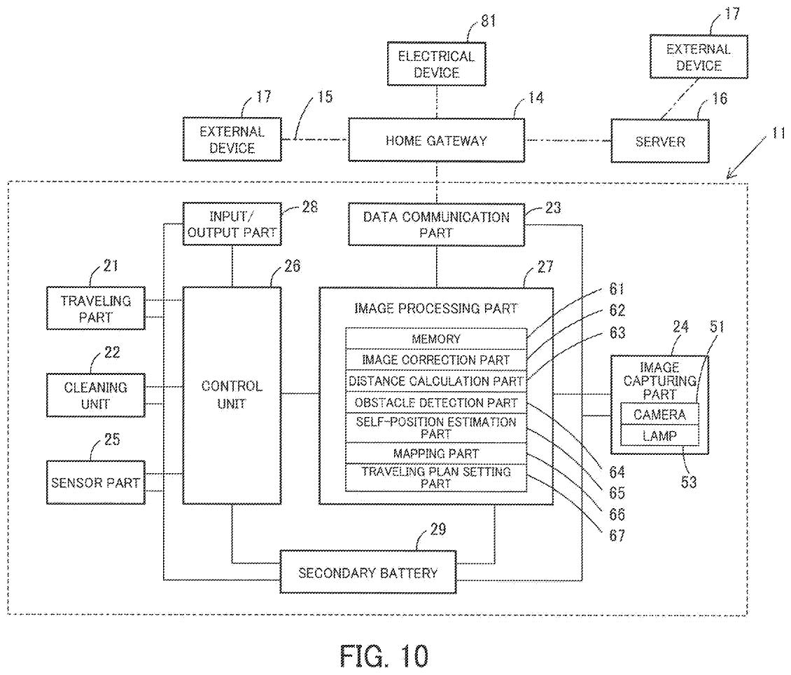

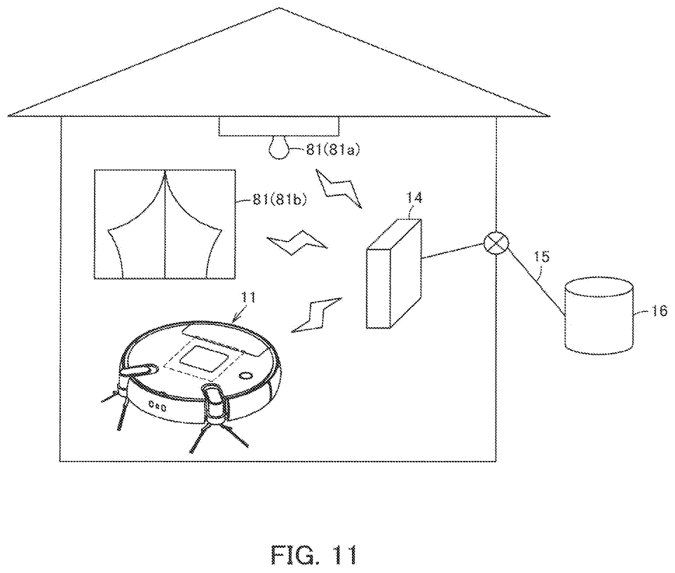

The third embodiment is described below with reference to FIG. 10 and FIG. 11. It is noted that identical reference signs are assigned to the configurations and effects similar to those of the respective embodiments described above, and the descriptions thereof are thus omitted.

The third embodiment includes the data communication part 23 corresponding to a wireless communication part serving as detection assisting means for outputting an instruction to instruct an electrical device 81 to assist detection. The electrical device 81 serves as an external device capable of adjusting a light quantity in the cleaning area, instead of the lamps 53 according to the respective embodiments described above.

For example, each of a lighting device 81a disposed on a ceiling or the like of the cleaning area, an electric curtain 81b for opening and closing covering a window disposed on a wall of the cleaning area, or the like is used as the electrical device 81. Each of these electrical devices 81 is capable of performing wireless communication with the vacuum cleaner 11 via the home gateway 14, as an example.

The data communication part 23 is capable of transmitting a control command to change (reduce) a light quantity in the cleaning area by operating the electrical device 81, by wireless communication. Specifically, in the case where the images captured by the cameras 51 are substantially uniform in luminance, the data communication part 23 determines that the cameras 51 are exposed to the light from the inside or the outside of the cleaning area, especially backlight, and is able to transmit the above-described control command by wireless communication. In the present embodiment, in an example, the lighting device 81a is switched off, or the electric curtain 81b is closed, thereby reducing the quantities of the light incident on the cameras 51.

Such reduction of the light quantity allows the extraction of the feature points from the images captured by the cameras 51. Thereby, the mapping part 66 is able to reflect the detailed information (height data) on the feature points on the basis of the extracted feature points, to complete the map, and the self-position estimation part 65 is also able to estimate the self-position of the vacuum cleaner 11 (the main casing 20).

As described above, the data communication part 23 is included, which corresponds to a wireless communication part for instructing the electrical device 81 corresponding to an external device to assist detection, thereby enabling to provide the feature points on the images captured by the cameras 51 in corporation with the electrical device 81.

Specifically, the electrical device 81 capable of adjusting a light quantity in the cleaning area is instructed to assist detection, via the data communication part 23. In the case where excessive light quantities of, for example, backlight incident on the cameras 51 causes so-called blown out highlights on the images captured by the cameras 51, and thereby feature points are not extracted or are hardly extracted, the control command is transmitted to the electrical device 81 via the data communication part 23, so as to make the electrical device 81 operate and adjust a light quantity. Thereby, the light quantities incident on the cameras 51 are enabled to be suppressed, and feature points are enabled to be extracted.

It is noted that in the third embodiment described above the data communication part 23 may be configured to directly instruct the electrical device 81 to assist detection, not via the home gateway 14.

The electrical device 81 may be configured to perform any detection assisting, for example, formation of light or a shade in a specified shape on an obstacle, not only decrease and increase of a light quantity in the cleaning area.

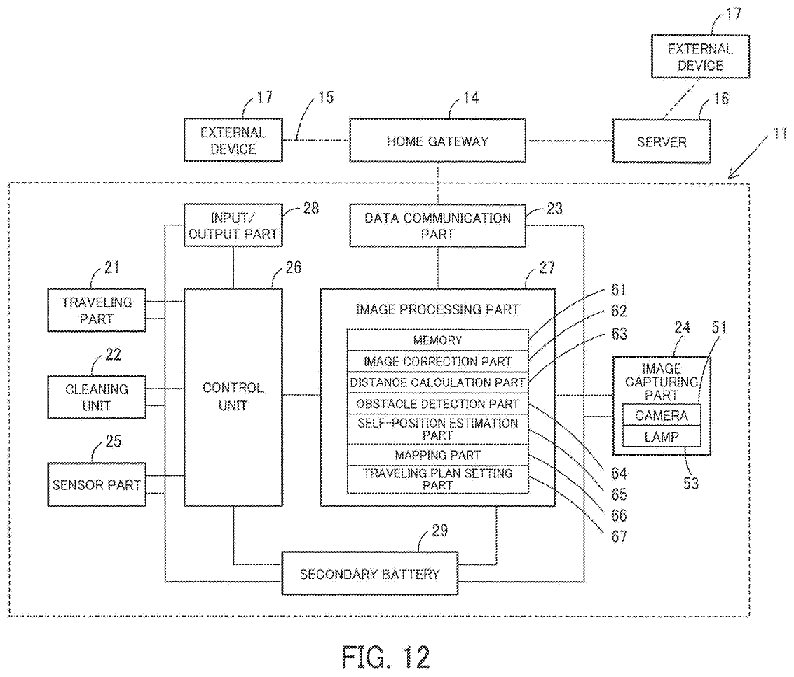

The fourth embodiment is described below with referent to FIG. 12. It is noted that identical reference signs are assigned to the configurations and effects similar to those of the respective embodiments described above, and the descriptions thereof are thus omitted.

The fourth embodiment is configured to include the sensor part 25 serving as detection assisting means. The sensor part 25 includes the function for detecting traveling information on the vacuum cleaner 11 (the main casing 20) to assist obstacle detection. The sensor part 25 includes a sensor for detecting a rotation angle and a rotation angular speed of each of the driving wheels 34 (each motor) on the basis of the detection by a rotational speed sensor, for example, an optical encoder for detecting rotational speed of each of the left and right driving wheels 34 (each motor). The sensor part 25 is capable of estimating (acquiring the odometry of) traveling information on, for example, a traveling distance from a reference position and a traveling direction of the vacuum cleaner 11 (the main casing 20). For example, the position of the charging device 12 from which traveling is started is set as the reference position. It is noted that the sensor part 25 may be configured so that, for example, a gyro-sensor estimates a direction of the vacuum cleaner 11 (the main casing 20), or alternatively the sensor part 25 may include another sensor, for example, an ultrasonic sensor, for detecting traveling information on the vacuum cleaner 11 (the main casing 20).

In the case where there is a wall without any pattern in front of the vacuum cleaner 11 (the main casing 20) in the traveling direction, or in the case where the vacuum cleaner 11 approaches an obstacle to a close range, as an example, the images captured by the cameras 51 are supposed to be substantially uniform in luminance, and thus have no feature point, or have extremely decreased feature points. In the case where the sensor part 25 becomes unable to detect at least a predetermined number of the feature points of the obstacle detected in front at a predetermined distance (for example, one meter), the sensor part 25 estimates the traveling route after the time point at which the detection becomes impossible, and grasps the remaining distance to the obstacle, whereby the obstacle detection part 64 indirectly detects the obstacle.

As described above, in the case where the obstacle detection part 64 is not able to detect an obstacle on the basis of the images captured by the cameras 51, the sensor part 25 assists the obstacle detection performed by the obstacle detection part 64, on the basis of the traveling information on the main casing 20, to estimate the remaining distance from the current position of the vacuum cleaner 11 (the main casing 20) to an obstacle, thereby enabling to continuously estimate the position of the detected obstacle.

The usage of the sensor part 25 generally included in the autonomous traveling type vacuum cleaner 11 allows the simple configuration thereof to facilitate the detection assisting, without requiring an additional configuration.

It is noted that the respective embodiments described above may be used in any combination thereof.

In the respective embodiments described above, although the distance calculation part 63 calculated the three-dimensional coordinates of feature points by use of the images respectively captured by the plurality (the pair) of cameras 51, the distance calculation part 63 may alternatively calculate the three-dimensional coordinates of feature points by use of the plurality of images captured by, for example, one camera 51 in a time division manner while the main casing 20 is being moved.

According to at least one of the embodiments described above, the lamps 53, the data communication part 23, the sensor part 25 or the like assists the detection performed by the obstacle detection part 64, thereby enabling to ensure the accuracy in the obstacle detection performed by the obstacle detection part 64. In addition, the control unit 26 controls the driving of the driving wheels 34 (motors) to make the vacuum cleaner 11 (the main casing 20) travel autonomously, on the basis of the information on the detected obstacle, thereby enabling to accurately make the vacuum cleaner 11 (the main casing 20) travel autonomously.

The time when the image is substantially uniform in luminance is set as the timing for detection assisting. Therefore, the detection assisting is enabled to be performed surely and efficiently.

The usage of the pair of cameras 51 allows accurate detection of the distances to feature points by application of triangulation by use of the images captured by the respective cameras 51, even under the state where the vacuum cleaner 11 (the main casing 20) is stopped.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

1: A vacuum cleaner comprising:
a main body;
a travel driving part configured to allow the main body to travel;
a camera disposed on the main body so as to capture an image in a traveling direction side of the main body;
an obstacle detection part configured to perform detection of an obstacle on a basis of the image captured by the camera;
a detection assisting part configured to assist the detection performed by the obstacle detection part; and
a controller configured to make the main body travel, by controlling driving of the travel driving part on a basis of the detection of the obstacle performed by the obstacle detection part.

2: The vacuum cleaner according to claim 1, wherein
the detection assisting part is a lamp configured to radiate light so as to form a specified shape in an image range of the camera.

3: The vacuum cleaner according to claim 2, wherein
the detection assisting part is a lamp configured to radiate infrared light so as to form a specified shape in the image range of the camera.

4: The vacuum cleaner according to claim 1, wherein
the detection assisting part projects a specified shape in an image range of the camera.

5: The vacuum cleaner according to claim 2, wherein
the detection assisting part forms a specified shape substantially at a central portion in the image range of the camera.

6: The vacuum cleaner according to claim 1, wherein
the detection assisting part is a wireless communication part configured to instruct an external device to assist detection.

7: The vacuum cleaner according to claim 6, wherein
the detection assisting part is the wireless communication part configured to instruct an electrical device capable of adjusting a light quantity in a cleaning area.

8: The vacuum cleaner according to claim 1, wherein
when the obstacle detection part is not able to detect any obstacle on a basis of the image captured by the camera, the detection assisting part assists the detection of an obstacle performed by the obstacle detection part, on a basis of traveling information on the main body.

9: The vacuum cleaner according to claim 1, wherein
at least one pair of the cameras is disposed.
